(19) United States
(12) Patent Application Publication
(10) Pub. No.: US 2013/0069980 A1
(43) Pub. Date: Mar. 21, 2013

(54) Dynamically Cropping Images

(71) Applicants: Beau R. Hartshorne, Palo Alto, CA (US); Nathaniel Gregory Roman, San Francisco, CA (US)

(72) Inventors: Beau R. Hartshorne, Palo Alto, CA (US); Nathaniel Gregory Roman, San Francisco, CA (US)

(21) Appl. No.: 13/233,245

(22) Filed: Sep. 15, 2011

(51) Int. Cl. G09G 5/00

(52) U.S. Cl. 345/620

(57) ABSTRACT

In one embodiment, in response to an action from a user, which results in an image to be displayed on a user device for the user: accessing information about the user and the image; cropping the image based at least on the information about the user and the image; and causing the cropped image to be displayed on the user device.

### TECHNICAL FIELD

This disclosure generally relates to image processing and more specifically relates to dynamically cropping images for display to users based on available information on the images, the users, the circumstances surrounding the display, and/or predefine policies.

### BACKGROUND

Cropping an image refers to the process of removing some parts of the image, usually for the purposes of improving framing, accentuating subject matter, or changing aspect ratio of the image. Many image processing software (e.g., Adobe Photoshop) provides image cropping capability, although most only supports manual cropping, in which case a user needs to manually select (e.g., using a mouse or a stylus) which portion of an image is to remain and the software removes the unselected portions of the image. Some image processing software also supports basic auto-cropping capability. For example, the software is able to automatically remove white spaces along the edges of an image.

### SUMMARY

This disclosure generally relates to image processing and more specifically relates to dynamically cropping images for display to users based on available information on the images, the users, the circumstances surrounding the display, and/or predefine policies.

In particular embodiments, in response to an action from a user, which results in an image to be displayed on a user device for the user: accessing information about the user and the image; cropping the image based at least on the information about the user and the image; and causing the cropped image to be displayed on the user device.

These and other features, aspects, and advantages of the disclosure are described in more detail below in the detailed description and in conjunction with the following figures.

### BRIEF DESCRIPTION OF THE DRAWINGS

FIG. 1 illustrates an example image of a relatively high resolution.

FIG. 2 illustrates resizing the image illustrated in FIG. 1 in order to display it in a relatively small area.

FIGS. 3-4 illustrate cropping the image illustrated in FIG. 1 in order to display it in a relatively small area.

FIG. 5 illustrates an example method for dynamically and automatically cropping an image.

FIG. 6 illustrates an example computer system.

FIG. 7 illustrates an example image of a relatively high resolution.

FIG. 8 illustrates cropping the image illustrated in FIG. 7 in order to display it in a relatively small area.

FIG. 9 illustrates an example image of a relatively high resolution.

FIG. 10 illustrates cropping the image illustrated in FIG. 7 in order to display it in a relatively small area.

### DESCRIPTION OF EXAMPLE EMBODIMENTS

This disclosure is now described in detail with reference to a few embodiments thereof as illustrated in the accompanying drawings. In the following description, numerous specific details are set forth in order to provide a thorough understanding of this disclosure. However, this disclosure may be practiced without some or all of these specific details. In other instances, well known process steps and/or structures have not been described in detail in order not to unnecessarily obscure this disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

Sometimes, an image of a relatively high resolution and thus a relatively large size needs to be displayed within a relatively small area. For example, a relatively large image may, at times, need to be presented as a thumbnail or an icon. In practice, this often happens when the screen of the device on which the image is displayed is relatively small, such as the screen of a mobile device (e.g., mobile telephone, tablet computer, etc.), although the same need may also arise with a device (e.g., a desktop computer) having a relatively large screen.

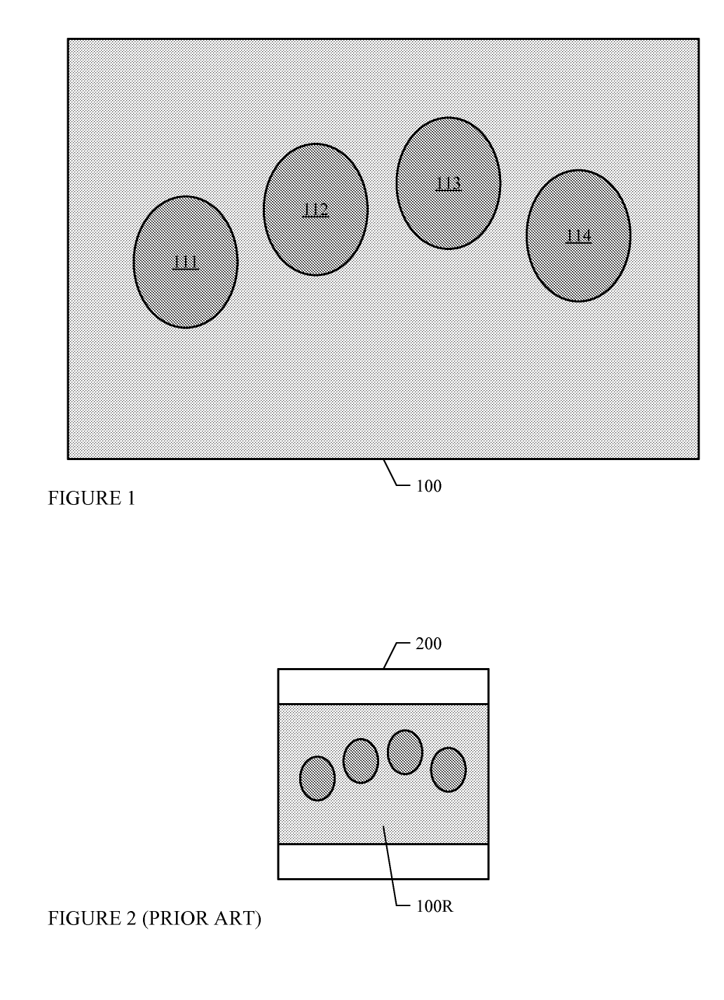

FIG. 1 illustrates an example image 100 of a relatively high resolution and thus having a relatively large size. For example, image 100 may be a digital photograph, and there are four people 111, 112, 113, 114 captured in image 100. Suppose that image 100 needs to be displayed within a relatively small area on the screen of a computing device (e.g., a mobile telephone or a tablet computer). That is, the area available for displaying image 100 is smaller, and sometimes, much smaller, than the actual size of image 100.

One way to achieve this is to resize image 100 down so that it fits inside the display area, as illustrated in FIG. 2. In FIG. 2, a display area 200 is smaller than the original size of image 100. Thus, image 100 is downsized using an appropriate resizing algorithm to get a smaller version of image 100, image 100R, which can fit inside display area 200. However, downsizing a larger image so that it fits into a smaller display area has several drawbacks. For example, once the image is downsized, many details in the original image are lost, and it is hard to determine which people or objects are captured in the image. Moreover, the aspect ratio of the display area may differ from the aspect ratio of the image (e.g., as in the case illustrated in FIG. 2), and so parts of the display area may be left blank.

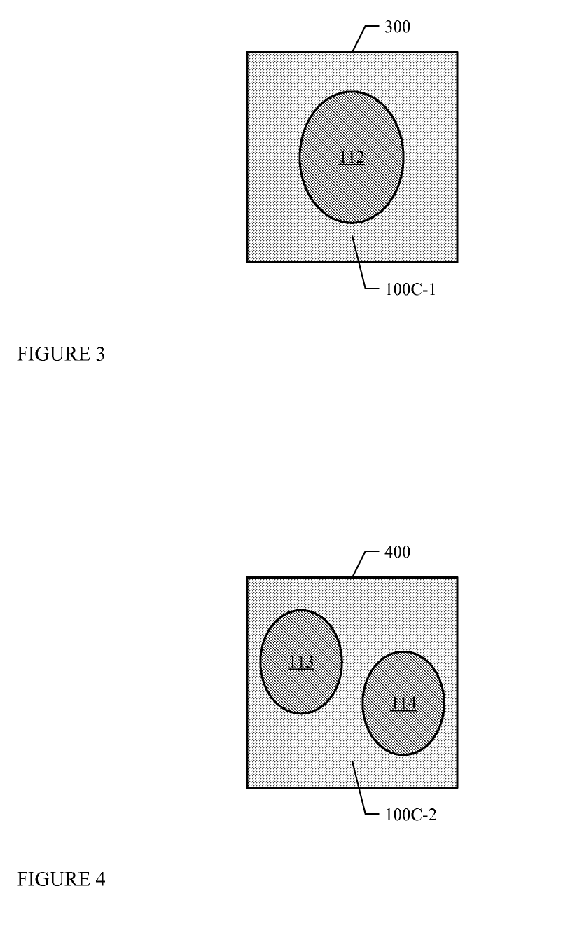

Instead of resizing a larger image to fit it inside a smaller display area, particular embodiments may automatically crop the larger image to fit the image inside the smaller display area, as illustrated in FIG. 3. In FIG. 3, again, a display area 300 is smaller than the original size of image 100. However, image 100 is cropped to obtain image 100C-1, which is the portion of image 100 that contains person 112. Image 100C-1 is displayed in area 300. In this case, because there is no downsizing of image 100, image 100C-1 retains all the details showing person 112 as contained in original image 100 so that person 112 is easily recognizable when cropped image 100C-1 is displayed in area 300. Moreover, image 100C-1 may be cropped to have the same aspect ratio as display area 300 so that it fills display area 300 completely.

In particular embodiments, images are cropped dynamically. That is, the same image may be cropped differently when it is displayed at different times. In FIG. 3, cropped image 100C-1 contains person 112. On the other hand, in FIG. 4, image 100 is cropped differently to obtain image 100C-2, which is the portion of image 100 that contains person 113 and person 114. Image 100C-2 is displayed in an area 400.

In particular embodiments, a cropped image may still need to be resized, up or down, in order to fit it inside a particular display area. For example, in FIG. 4, in order to fit both person 113 and person 114 inside display area 400, cropped image 100C-2 still needs to be downsized slightly. However, the amount of downsizing required to fit cropped image 100C-2 inside display area 400 is much less than the amount of downsizing required to fit original image 100 inside display area 400. Thus, not much detail is lost when downsizing cropped image 100C-2, and person 113 and person 114 are still easily recognizable when image 100C-2 is displayed in area 400.

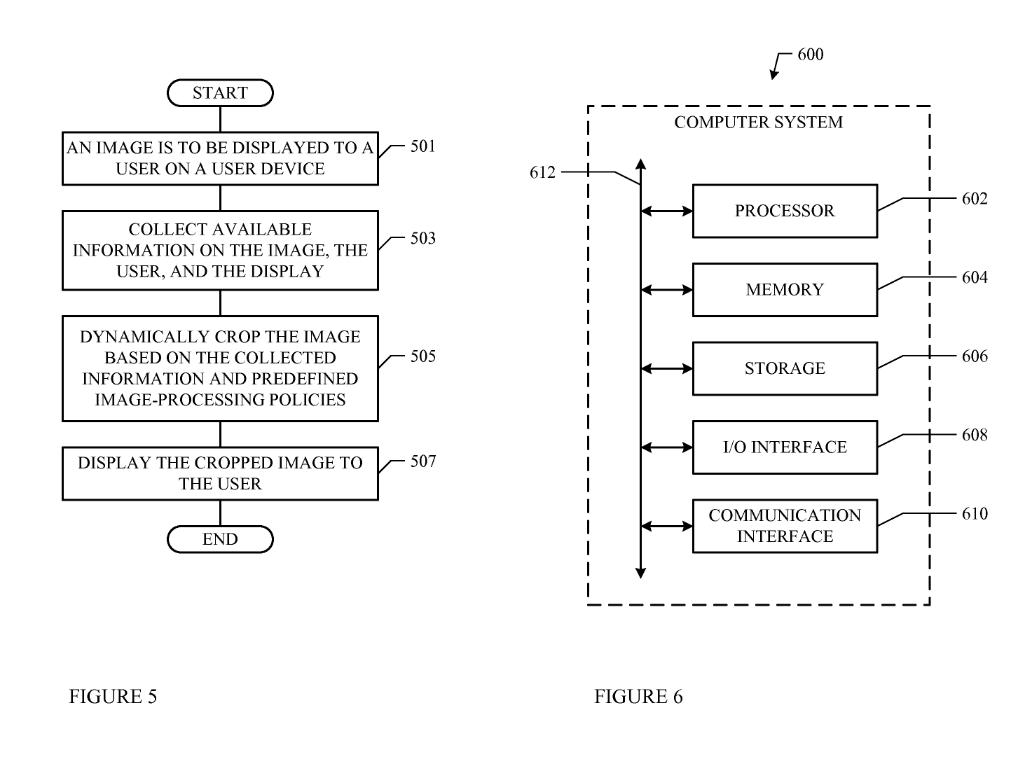

In particular embodiments, each time a specific image needs to be displayed in an area smaller than the original size of the image, the image may be cropped based on various factors and policies. Optionally, the cropped image may be resized, either up or down, so that it fits the display area better. FIG. 5 illustrates an example method for dynamically and automatically cropping an image.

Suppose that an image is to be displayed to a user on a device associated with the user, as illustrated in STEP 501. This may be the result of a user action performed by the user on the user device. For example, the user may have requested to view the profile (e.g., social profile) of another person, and the image of that other person needs to be displayed as a part of the profile. The user may have conducted a search for images relating to a subject matter specified as a search query (e.g., images of the Golden Gate Bridge in San Francisco, or images of Angelina Jolie), and the image is one of the search results. The user may have clicked on a news article supplied to the user device through a news feed to review its content, and there is an image contained in the article or related to the news story. The present disclosure contemplates any applicable cause that results in an image being displayed to a user on a user device associated with the user.

Particular embodiments may collect available information on the image, the user, the user device, and/or other relevant factors, as illustrated in STEP 503. Particular embodiments may also access predefined rules or policies that govern how the image should be cropped and/or resized.

First, with respect to the image, particular embodiments may determine the original size or resolution of the image, metadata (e.g., tags) associated with the image (e.g., names of the people captured in the image, descriptions of the objects captured in the image, names of the places in the image, etc.), features (e.g., people, objects, places, etc.) captured in the image, the context in which the image is displayed (e.g., the image is displayed in connection with a profile of a person, a news item, an advertisement, etc.), the owner of the image and/or whether the owner is captured in the image, the profile of the owner of the image, the album, if any, to which the image belongs, and other relevant information about the image. For example, the image may be associated with various tags. If the image captures one or more people (e.g., image 100), the name of each person captured in the image may be tagged with the image or next to the person. If the image captures a specific location (e.g., the Golden Gate Bridge), the name of the location may be tagged with the image. If the image captures one or more objects, the description of each object captured in the image may be tagged with the image. Various image processing algorithms (e.g., facial recognition, object detection, etc.) may be applied to the image to extract the features (e.g., people, objects, places, etc.) captured in the image.

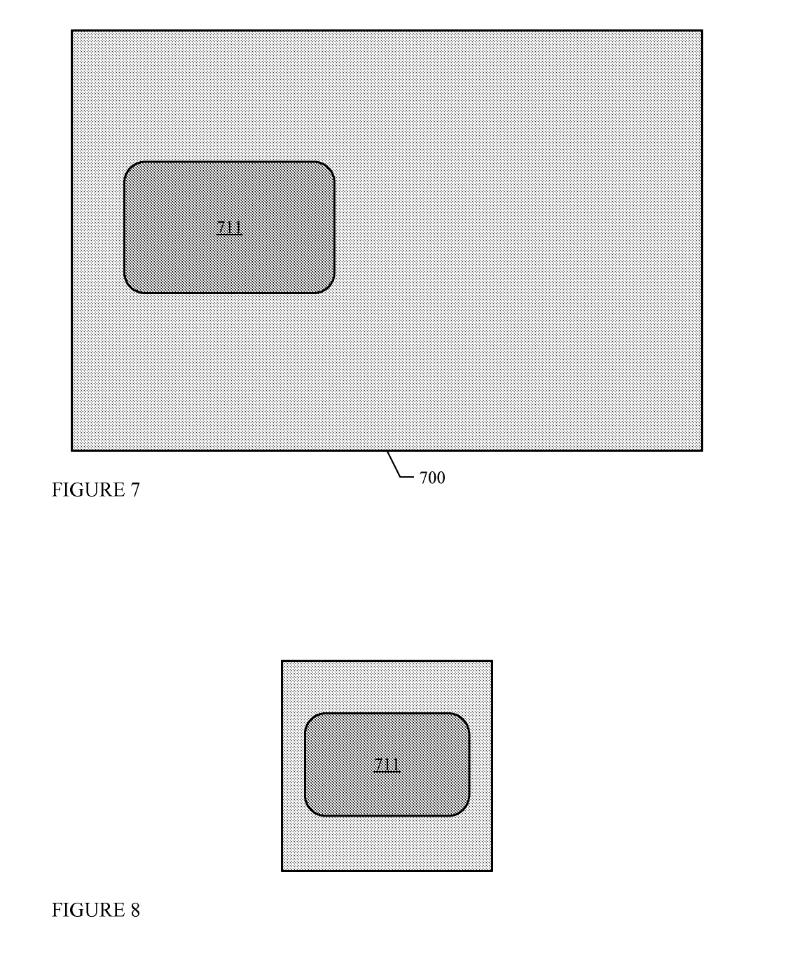

For example, facial recognition algorithms may be applied to image 100 to determine the names (e.g., Jane, John, Michael, and Mary) of persons 111, 112, 113, and 114, respectively. The tags associated with image 100, if available, may also help determine the names of persons 111, 112, 113, and 114. As another example, FIG. 7 illustrates an example image 700 that contains an object 711 (e.g., a car). Object detection algorithms may be applied to image 700 to determine what object 711 is, and the tags associated with image 700, if available, may also help identify object 711.

The image may be displayed in a specific context. For example, the image may be associated with a person whose profile the user has requested. The image may be associated with a news story from a news feed or a relationship story. The image may be a part of an online photo album the user wishes to view. The image may be associated with a social advertisement. The image may be one of the search results identified for a search query provided by the user (e.g., image search or browsing).

Second, with respect to the user to whom the image is to be presented (i.e., the viewer of the image), particular embodiments may determine who the user is, the relationship between the user and the people, objects, or locations captured in the image or the owner of the image, the reason that the image is to be presented to the user, and other relevant information about the user.

In particular embodiments, the user may be a member of a social-networking website. A social network, in general, is a social structure made up of entities, such as individuals or organizations, that are connected by one or more types of interdependency or relationships, such as friendship, kinship, common interest, financial exchange, dislike, or relationships of beliefs, knowledge, or prestige. In more recent years, social networks have taken advantage of the Internet. There are social-networking systems existing on the Internet in the form of social-networking websites. Such social-networking websites enable their members, who are commonly referred to as website users, to perform various social activities. For example, the social-networking website operated by Facebook, Inc. at www.facebook.com enables its users to communicate with their friends via emails, instant messages, or blog postings, organize social events, share photos, receive news of their friends or interesting events, play games, etc.

For example, if the image captures one or more persons (e.g., image 100), some or all the people captured in the image may also be members of the same social-networking website to which the user belongs. There may be social connections or social relationships between the user and some or all the people captured in the image since they are all members of the same social-networking website. The connection between the user and one person captured in the image may differ or may be closer than the connection between the user and another person captured in the image. Sometimes, a person may specify who is or is not authorized to view an image containing the person or belonging to the person. In this case, for each person captured in the image, particular embodiments may determine whether the user is authorized to view an image of that person.

As another example, if the image captures one or more objects (e.g., image 700), the user may own, may be interested in, may be an expert on, or may wish to purchase one of the objects captured in the image. As a third example, if the image captures a place, the owner may have been to the place, or may wish to visit the place.

Third, with respect to the user device on which the image is to be displayed, particular embodiments may determine the size and aspect ratio of the display area in which the image is to be displayed, the size of the screen of the user device, the location on the screen where the image is to be displayed, and other relevant factors.

In addition, in particular embodiments, there may be predefined image-processing rules or policies that help specify how an image should be cropped. The present disclosure contemplates any applicable image-processing rule or policy.

For example, aesthetically speaking, it is usually desirable to place a subject matter (e.g., person, object, or place) of an image near the center of the image. In the case of image 700, object 711 is placed to the left side of image 700, while the right side of image 700 is left blank. Thus, from an aesthetic point of view, when cropping an image, a policy may indicate that it is desirable to remove large blank portions of the image. Thus, when cropping image 700, the blank right side of image 700 may be removed in order to move object 711 near the center of the cropped image, as illustrated in FIG. 8.

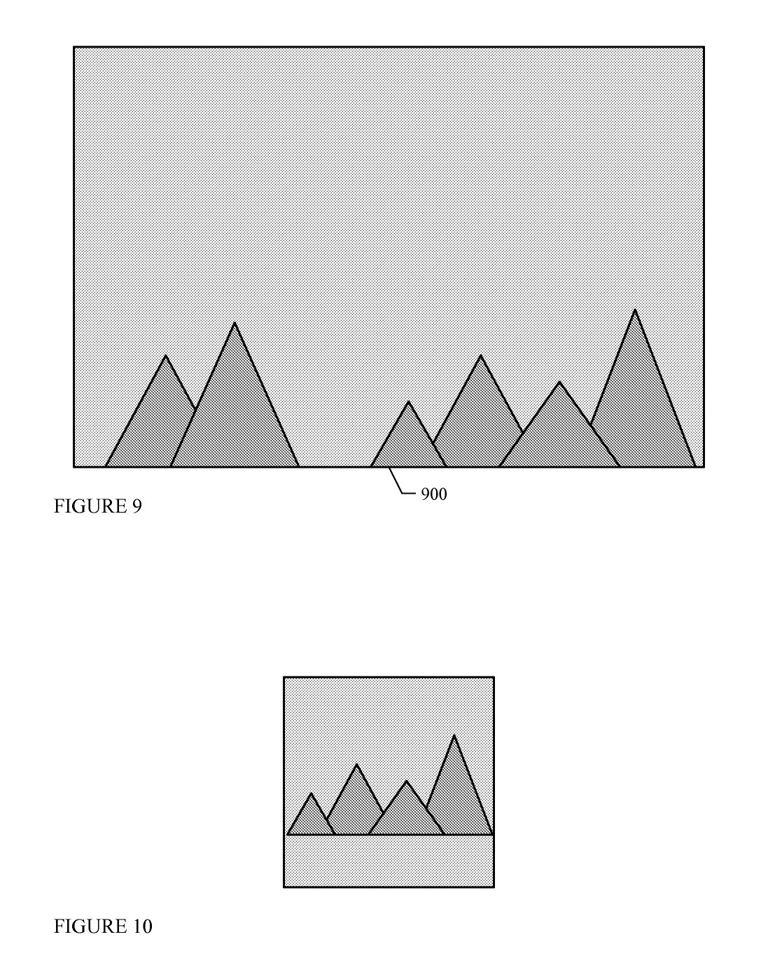

As another example, FIG. 9 illustrates an image 900 where the bottom portion of the image contains some interesting landscaping features but the top portion of the image is mainly featureless sky. Based on what is generally considered good image composition, when cropping an image, a policy may indicate that it is desirable to remove large featureless portions of the image. Thus, when cropping image 900, it may be desirable to remove the mostly featureless top portion of image 900 in order to move the landscaping features near the center of the cropped image, as illustrated in FIG. 10. In addition, as illustrated in FIG. 10, the cropped image may be repositioned inside the display area so that it looks more aesthetically pleasing.

As another example, when cropping an image, a policy may indicate that the cropped area preferably contains one or more people. Thus, if there is any person captured in an image, the cropped area may focus on the person. If there is no person captured in an image, the cropped area may then focus on objects or places.

Particular embodiments may dynamically crop the image based on the collected information and/or the predefined image-processing policies, as illustrated in STEP 505. Different information may be used differently when determining how an image should be cropped. For example, consider image 100, which captures four people. Suppose that the user has requested to view the profile of person 111. In this case, persons 112, 113, and 114 are probably of no interest to the user. Therefore, when cropping image 100, the cropped image may only contain the face of person 111, and persons 112, 113, and 114 are left out of the cropped image. Alternatively, suppose that the user is one of the persons captured in image 100 (e.g., person 112), and the user wishes to view an album of photographs taken at an event, which both the user and person 113 have attended. In this case, when cropping image 100, the cropped image may contain both person 112 (i.e., the user) and person 113. Alternatively, suppose that the user has requested a search for images of Mary (i.e., person 114). In this case, when cropping image 100 as one of the search results, the cropped image may contain only person 114. Alternatively, suppose that the user wishes to read a news story about person 112. In this case, when cropping image 100 to be displayed in connection with the news story, the cropped image may contain only person 112.

As another example, suppose that person 113 has specified viewing rights for his images, and the user is not authorized to view images that contain person 113. If image 100 is to be displayed for the user, person 113 may be cropped out so that his face is not shown to the user.

As another example, suppose that an image contains several objects, and the user is interested in one specific object in particular (e.g., the user has expressed a desire to purchase the object). When cropping such an image for the user, the object of interest to the user may be included in the cropped image, while the other objects may be left out.

As another image, again consider image 100, which captures four people. Suppose that the user has social connections or relationships with persons 113 and 114 but does not know persons 111 and 112 (e.g., according to their profiles with the social-networking website). In this case, when cropping image 100 for the user, the cropped image may only contain persons 113 and 114, as persons 111 and 112 are strangers and thus of no interest to the user.

As another example, the aspect ratio of the display area may help determine the aspect ratio of the cropped image. The size of the display area may help determine whether the cropped image needs to be resized up or down so that it may fit better inside the display area. If the cropped image is smaller than the display area, it may be resized up accordingly. Conversely, if the cropped image is larger than the display area, it may be resized down accordingly.

As the above examples illustrate, information about the user (i.e., the viewer of the image), about the image itself, about the user device, and other types of relevant information may all help determine how an image should be cropped for a given user in a given context at a given time and location. The same image may be cropped differently for different users or in different contexts or different times and locations. In particular embodiments, the cropped image may contain subject matter (e.g., person, object, location, etc.) that is relevant to the given user in the given context. In addition, image-processing policies may help determine how an image should be cropped so that the cropped image appears more aesthetically pleasing.

In particular embodiments, the image may be stored on a server and sent to the user device (i.e., the client) for display when needed. The cropping of the image may be performed on the server (i.e., before the image is sent to the user device) or on the user device (i.e., after the image is received at the user device).

If the cropping is performed at server side, in one implementation, the server may determine how the image should be cropped, generate a new image that only contains the cropped area of the original image (i.e., the cropped image), and send the cropped image to the user device for display. In this case, a client application (e.g., a web browser) executing on the user device may simply display the entire cropped image received from the server, as illustrated in STEP 507. Alternatively, in another implementation, the server may determine how the image should be cropped, obtain the coordinates of the cropped area in reference to the original image (e.g., using X and Y coordinates and width and height), send the original image together with the coordinates of the cropped area (e.g., using Cascading Style Sheets (CSS) code) to the user device for display, as illustrated in STEP 507. In this case, the client application (e.g., a web browser) executing on the user device may interpret the coordinates of the cropped area in reference to the original image so that when the image is displayed to the user, only the cropped area is visible.

If the cropping is performed at client side (i.e., by the user device), in one implementation, the server may send the original image to the user device. The user device may collect additional information from various information sources (e.g., the social-networking website, other servers, the Internet, the storage of the user device, etc.), and then determine how the image should be cropped. The user device may then display the cropped area of the image to the user, as illustrated in STEP 507.

The dynamic cropping of an image may be implemented as computer software, and the code may be written in any suitable programming language (e.g., C, Java, server-side or client-side scripting language such as PHP or JavaScript, etc.). An example code, written in PHP, for dynamically cropping an image is illustrated in the Appendix.

Particular embodiments may be implemented on one or more computer systems. FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 600 may include one or more computer systems 600; be unitary or distributed; span multiple locations; span multiple machines; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include an HDD, a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 602 (such as, for example, one or more internal registers or caches), one or more portions of memory 604, one or more portions of storage 606, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA, C, or C++. In particular embodiments, software is expressed in Hyper Text Markup Language (HTML), Extensible Markup Language (XML), or other suitable markup language.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

APPENDIX
SAMPLE CODE

```
<?php
// Copyright 2004-present Facebook. All Rights Reserved.
class PhotoCrop {
  private
    $cropHeight,
    $cropWidth,
    $faceboxes,
    $photo,
    $tags,
    $thumbsize;
  /**
  * Constructor for the class
  *
```

| | |
|---|---|
| * @param EntPhoto | Photo to be cropped |
| * @param string | Constant thumbnail size |
| * @param int | Width of the cropping area |
| * @param int | Height of the cropping area |
| * | |
| */ | |

```
  public function _construct($photo,
                        $thumbsize,
                        $crop_width =
PhotobarConsts::THUMB_WIDTH,
                        $crap_height =
PhotobarConsts::THUMB_HEIGHT) {
    $this->photo = $photo;
    $this->thumbsize = $thumbsize;
    $this->cropWidth = $crop_width;
    $this->cropHeight = $crop_height;
  }
  public function setTags($tags) {
    $this->tags = $tags;
    return $this;
  }
  public function setFaceboxes($faceboxes) {
    $this->faceboxes = $faceboxes;
    return $this;
  }
  private function checkSubInterval($x1, $x2, $x3, $x4) {
    // Is interval [x1,x2] a proper sub interval of [x3,x4]
    return $x1 >= $x3 && $x1 <= $x4
            && $x2 >= $x3 && $x2 <= $x4;
  }
  private function computeBestOffset($face_pos) {
    $normal_size = $this->photo->
getDimensionsVector2(PhotoSizeConst::NORMAL);
    $size = $this->photo->getDimensionsVector2($this->
thumbsize);
    $invalid = (
      !$face_pos ||
      !$size->getWidth( ) ||
      !$normal_size->getWidth( ) ||
      !$size->getHeight( ) ||
      !$normal size->getHeight( )
    );
    if ($invalid) {
      return new Vector2(0,0);
    }
    $offset_x = null;
    $offset_y = null;
    $scaling_factor_x = $size->getWidth( ) / $normal_size->
getWidth( );
    $scaling_factor_y = $size->getHeight( ) / $normal_size->
getHeight( );
    $possible_x = array( );
    $possible_y = array( );
    foreach ($face_pos as $face) {
      // Transform the face dimension from normal dimensions
      // to thumb size scale
      $face[‘left’] *= $scaling_factor_x;
      $face[‘right’] *= $scaling_factor_x;
      $face[‘top’] *= $scaling_factor_y;
      $face[‘bottom’] *= $scaling_factor_y;
      $possible_x[ ] = $face[‘left’];
      $possible_y[ ] = $face[‘top’];
    }
    $best_region = null;
    $max_face_cnt = −1;
    // If we ignore the photo boundaries there will be an
    // optimal bounding rectangle which is along the current
    // top and left boundaries of faces
    foreach ($possible_x as $left)
      foreach ($possible_y as $top) {
        $current_region = array( );
        $current_region[‘left’] = $left;
        $current_region[‘top’] = $top;
        $current_region[‘right’] = $left + $this->cropWidth;
        $current_region[‘bottom’] = $top + $this->cropHeight;
        $current_face_cnt = 0;
        foreach ($face_pos as $face) {
          $x_overlap = $this->
checkSubInterval($face[‘left’],$face[‘right’],
          $current_region[‘left’],$current_region[‘right’]);
          $y_overlap = $this->
checkSubInterval($face[‘top’],$face[‘bottom’],
            $current_region[‘top’],$current_region[‘bottom’]);
          if ($x_overlap && $y_overlap){
            $current_face_cnt++;
          }
        }
        if ($current_face_cnt > $max_face_cnt) {
          $max_face_cnt = $current_face_cnt;
          $best_region = $current_region;
        }
      }
    // we can't be more than _play away from 0
    $x_play = $size->getWidth( ) − $this->cropWidth;
    $y_play = $size->getHeight( ) − $this->cropHeight;
    // center the faces
    $center_x =
      ($best_region[‘right’] − $best_region[‘left’]) / 2 +
$best_region[‘left’];
    $center_y =
      ($best_region[‘bottom’] − $best_region[‘top’]) / 2 +
$best_region[‘top’];
    $offset_x =
      min($x_play, round($center_x − $this->cropWidth / 2));
    $offset_y =
      min($y_play, round($center_y − $this->cropHeight / 2));
    $offset_x = max($offset_x, 0);
    $offset_y = max($offset_y, 0);
    return new Vector2(−$offset_x, −$offset_y);
  }
  /**
  * Get the position attribute for fb:photos:cropped-thumb
  *
  * @param int The user to be focused, if this parameter
  * is not passed or set to null, position which focuses on
  * the maximum number of people is returned
  *
  * @return Vector2 with the given position
  */
  public function getBestPosition($focus_user=null) {
    $face_collection = array( );
    $normal_size = $this->photo->
getDimensionsVector2(PhotoSizeConst::NORMAL);
    /*
    * NOTE: PhotoTagConstants::MAX_WIDTH stores the radius
    * instead of the actual width
    */
    $tag_size = PhotoTagConstants::MAX_WIDTH;
    foreach ((array)$this->tags as $tag) {
      $current_face = array( );
      $x = $tag->getX( ) / 100 * $normal_size->getWidth( );
      $y = $tag->getY( ) / 100 * $normal size->getHeight( );
      $current_face[‘left’] = $x − $tag_size;
      $current_face[‘right’] = $x + $tag_size;
      $current_face[‘top’] = $y − $tag_size;
      $current_face[‘bottom’] = $y + $tag_size;
      if ($focus_user === $tag->getSubjectID( )) {
        return $this->computeBestOffset(array($current_face));
      }
      $face_collection[ ] = $current_face;
    }
    foreach ((array)$this->faceboxes as $facebox) {
      $rect = $facebox->getRect( );
      $current_face = array( );
      $current_face[‘left’] = $rect->getLeft( );
      $current_face[‘right’] = $rect->getRight( );
      $current_face[‘top’] = $rect->getTop( );
      $current_face[‘bottom’] = $rect->getBottom( );
      $face_collection[ ] = $current_face;
    }
    return $this->computeBestOffset($face_collection);
  }
}
```

What is claimed is:

1. A method comprising: by one or more computing devices,
in response to an action from a user, which results in an image to be displayed on a user device for the user:
accessing information about the user and the image;
cropping the image based at least on the information about the user and the image; and
causing the cropped image to be displayed on the user device.

2. The method of claim 1, wherein the information about the user comprises an identity of the user, and social-networking information about the user.

3. The method of claim 1, wherein the information about the image comprises a resolution of the image, metadata associated with the image, a context in which the image is to be displayed, an owner of the image, one or more features captured in the image, and one or more relationships between the user and at least one feature captured in the image.

4. The method of claim 1, further comprising accessing information about the user device, wherein the image is cropped further based on the information about the user device.

5. The method of claim 4, wherein the information about the user device comprises a display area inside which the cropped image is to be displayed, and a location of the display area on the user device.

6. The method of claim 1, further comprising accessing one or more predefined policies, wherein the image is cropped further based on the one or more predefined policies.

7. The method of claim 1, wherein causing the cropped image to be displayed on the user device comprises:
cropping the image to obtain the cropped image; and
sending the cropped image to the user device to be displayed.

8. The method of claim 1, wherein causing the cropped image to be displayed on the user device comprises:
specifying a cropped area within the image; and
sending the image and the specification of the cropped area to the user device.

9. A system comprising:
a memory comprising instructions executable by one or more processors; and
the one or more processors coupled to the memory and operable to execute the instructions, the one or more processors being operable when executing the instructions to:
in response to an action from a user, which results in an image to be displayed on a user device for the user:
access information about the user and the image;
crop the image based at least on the information about the user and the image; and
cause the cropped image to be displayed on the user device.

10. The system of claim 9, wherein the information about the user comprises an identity of the user, and social-networking information about the user.

11. The system of claim 9, wherein the information about the image comprises a resolution of the image, metadata associated with the image, a context in which the image is to be displayed, an owner of the image, one or more features captured in the image, and one or more relationships between the user and at least one feature captured in the image.

12. The system of claim 9, wherein the one or more processors are further operable when executing the instructions to access information about the user device, wherein the image is cropped further based on the information about the user device.

13. The system of claim 12, wherein the information about the user device comprises a display area inside which the cropped image is to be displayed, and a location of the display area on the user device.

14. The system of claim 9, wherein the one or more processors are further operable when executing the instructions to access one or more predefined policies, wherein the image is cropped further based on the one or more predefined policies.

15. The system of claim 9, wherein causing the cropped image to be displayed on the user device comprises:
crop the image to obtain the cropped image; and
send the cropped image to the user device to be displayed.

16. The system of claim 9, wherein causing the cropped image to be displayed on the user device comprises:
specify a cropped area within the image; and
send the image and the specification of the cropped area to the user device.

17. One or more computer-readable non-transitory storage media embodying software operable when executed by one or more computer systems to:
in response to an action from a user, which results in an image to be displayed on a user device for the user:
access information about the user and the image;
crop the image based at least on the information about the user and the image; and
cause the cropped image to be displayed on the user device.

18. The media of claim 17, wherein:
the information about the user comprises an identity of the user, and social-networking information about the user; and
the information about the image comprises a resolution of the image, metadata associated with the image, a context in which the image is to be displayed, an owner of the image, one or more features captured in the image, and one or more relationships between the user and at least one feature captured in the image.

19. The media of claim 17, wherein the software is further operable when executed by one or more computer systems to access information about the user device, wherein:
the image is cropped further based on the information about the user device; and
the information about the user device comprises a display area inside which the cropped image is to be displayed, and a location of the display area on the user device.

20. The media of claim 17, wherein the software is further operable when executed by one or more computer systems to access one or more predefined policies, wherein the image is cropped further based on the one or more predefined policies.
